(19) United States
(12) Patent Application Publication
(10) Pub. No.: US 2026/0019176 A1
(43) Pub. Date: Jan. 15, 2026

(54) METHODS AND PROCEDURES FOR PREDICTIVE BEAM REFINEMENT

(71) Applicant: InterDigital Patent Holdings, Inc., Wilmington, DE (US)

(72) Inventors: Arman Shojaeifard, London (GB); Young Woo Kwak, Woodbury, NY (US); Yugeswar Deenoo Narayanan Thangaraj, Chalfont, PA (US); Nazli Khan Beigi, Longueuil (CA); Tejaswinee Lutchoomun, Montreal (CA); Haseeb Ur Rehman, Winnipeg (CA); Satyanarayana Katla, London (GB)

(73) Assignee: InterDigital Patent Holdings, Inc., Wilmington, DE (US)

(21) Appl. No.: 18/881,062

(22) PCT Filed: Aug. 8, 2023
(86) PCT No.: PCT/US2023/071837

§ 371 Date: Jan. 3, 2025

Related U.S. Application Data
(60) Provisional application No. 63/395,884, filed on Aug. 8, 2022.

(51) Int. Cl. H04B 17/318; H04B 7/06

(52) U.S. Cl. CPC H04B 17/328; H04B 7/0695

(57) ABSTRACT

A wireless transmit/receive unit (WTRU) may be configured to receive a configuration for predictive beam refinement. The configuration may include at least one threshold. The at least one threshold may be related to information. The information may be used to predict and/or select one or more beam-pairs. The WTRU may perform measurements on one or more reference signal (RS) sets. The WTRU may determine to store one or more of the measurements, for example as training data samples in a memory. The WTRU may determine to store the one or more measurements based on a comparison of the one or more measurements against the at least one threshold. The WTRU may determine to begin training or retraining a model for performing a prediction related to the one or more beam pairs. The WTRU may transmit an indication that the stored training data samples have reached the at least one threshold.

### CROSS-REFERENCE TO RELATED APPLICATIONS

This application claims the benefit of U.S. Provisional Patent Application No. 63/395,884 filed on 8 Aug. 2022, the entire contents of which are incorporated herein by reference.

### BACKGROUND

Beam management (e.g., in NR) may relate to selection, adjustment, and/or tracking of transmit (Tx) and receive (Rx) beams, which may be categorized into P-1, P-2, and P-3 procedures. Beam management (e.g., in NR) may be based on a beam searching principle with gNB transmission of downlink signals (e.g., synchronization signal block (SSB)/channel state information-reference signal (CSI-RS), etc.) and/or WTRU measurement and reporting procedures to identify a suitable (e.g., the best) beam. Beam sweep and measurement operation may consume significant resources from both Tx and Rx sides, and/or may also result in latency (e.g., for a large number of beams and/or at high frequencies).

Artificial Intelligence and/or Machine Learning (AI/ML) may be implemented in relation to the air interface (e.g., NR air interface) and/or beam management. AI/ML may be used as a framework for improving performance and complexity, for example, in relation to beam management (e.g., including beam prediction in time, and/or spatial domain for overhead and latency reduction, beam selection accuracy improvement, etc.). If beam management and/or beam predictions is based on AI/ML framework, certain challenges associated with beam measurement and reporting (e.g., as well as training and validation of the AI/ML model in scenarios with hierarchical spatial relations and beam associations in different frequency ranges) may be addressed. For example, data-driven WTRU inferences and behavior may be used to determine/perform the associations, measurement, and reporting associated with beam resources (e.g., as well as training, validation, activation and/or deactivation of the AI/ML models), which may be used to enable predictive beam establishment/refinement.

### SUMMARY

Data-driven (e.g., via an artificial intelligence/machine learning (AI/ML) model) beam prediction and/or establishment may be performed. For example, configuration information associated with beam sweeping may be received. For example, the configuration information may include a buffer size associated with an AI/ML model and/or a threshold quality metric. Beam sweeping may be performed across one or more beams, for example, based on the configuration information. The AI/ML model may be trained based on the beam sweeping performed across the one or more beams. For example, the AI/ML model may be implemented at a wireless transmit receive unit (WTRU) and/or a network node (e.g., a gNB). Training the AI/ML model may further comprise determining a quality metric associated with each of the one or more beams for which beam sweeping is performed, and filling a buffer associated with AI/ML mode based on whether the determined quality metric associated with each of the one or more beams is greater than the threshold (e.g., received via the configuration information). Using the AI/ML model, a beam of the one or more beams may be identified, and an indication of the identified beam may be sent. After the beam has been identified, a quality metric associated with the identified beam may be periodically measured. If the quality metric associated with the identified beam is below a second threshold, the AI/ML model may be retrained.

A WTRU may be configured to receive a configuration for predictive beam refinement. The configuration may include at least one threshold. The at least one threshold may be related to information. The information may be used to predict and/or select one or more beam-pairs. The WTRU may perform measurements on one or more reference signal (RS) sets. The WTRU may determine to store one or more of the measurements, for example as training data samples in a memory. The WTRU may determine to store the one or more measurements based on a comparison of the one or more measurements against the at least one threshold. The WTRU may determine, for example based on the at least one threshold, to begin training or retraining a model for performing a prediction related to the one or more beam pairs. The WTRU may transmit an indication. The indication may include that the stored training data samples have reached the at least one threshold.

The WTRU may predict measurements, for example for the one or more beam-pairs. For example, the WTRU may predict measurements based on the stored training data samples and/or a predictive beam refinement configuration. The WTRU may report one or more of predictive beam identifiers, codebook identifiers, predictive layer 1 received signal received power (L1-RSRP) values, or predictive angle of arrival (AoA), for example based on the predicted measurements. The at least one threshold may include at least one of a buffer size threshold related to the memory for indicating a maximum number of samples of beam quality measurement or beam combining weight pairs, a threshold related to a maximum buffer size or remaining buffer size, a threshold related to one or more measurements to be performed on one or more RS sets, a threshold number of comparisons of one or more measurements against one or more thresholds, an AI/ML model being completed, and/or one or more thresholds to determine to store a sample in the memory. The WTRU may retrieve stored training data samples from the memory, based on receipt of the configuration.

The determination to begin predicting measurements for the one or more beam-pairs may be made at the WTRU and/or at a network entity. The at least one threshold may be related to the information to be used to predict and/or select the one or more beam-pairs.

The WTRU may store the one or more of the measurements as training data samples in the memory, for example when the one or more measurements is greater than or equal to the at least one threshold. The WTRU may repeat the determination to store the one or more of the measurements as training data samples in the memory, for example when the one or more measurements is less than the at least one threshold.

The WTRU may calculate a prediction accuracy of measurements for the one or more beam-pairs, for example based on the stored training data samples. The at least one threshold may include a value which increases with the stored training data samples. Predicting measurements for the one or more beam-pairs may be based on weight vectors.

The embodiments described herein may implement artificial intelligence (AI) and/or machine learning (ML) algorithms (e.g., models). For example, a WTRU and/or a network may use one or more AI/ML models to predict measurements and refine predictions for beam pairs. As used herein, the term “artificial intelligence” and/or “AI” may include the behavior exhibited by one or more machines that mimic one or more cognitive functions (e.g., to sense, reason, adapt, and/or act).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A is a schematic illustration of an example system environment that may implement an artificial intelligence (AI) and/or machine learning (ML) model.

FIG. 2B illustrates an example of a neural network.

FIG. 2C is a schematic illustration of an example system environment for training and/or implementing an AI/ML model that includes a neural network (NN).

FIG. 2D is a schematic illustration of an example system environment for training and/or implementing an AI/ML model that includes an auto-encoder.

FIG. 3 is a schematic illustration of an example of training of an AI/ML model.

FIG. 4 is a schematic illustration of an example of inferring beam prediction performance.

FIG. 5 is a flow diagram illustrating an example procedure for predictive beam refinement.

### DETAILED DESCRIPTION

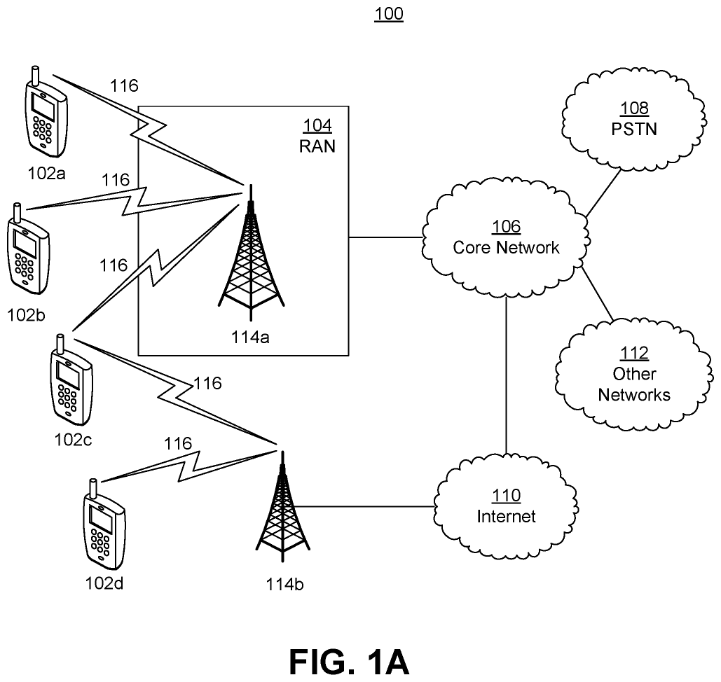

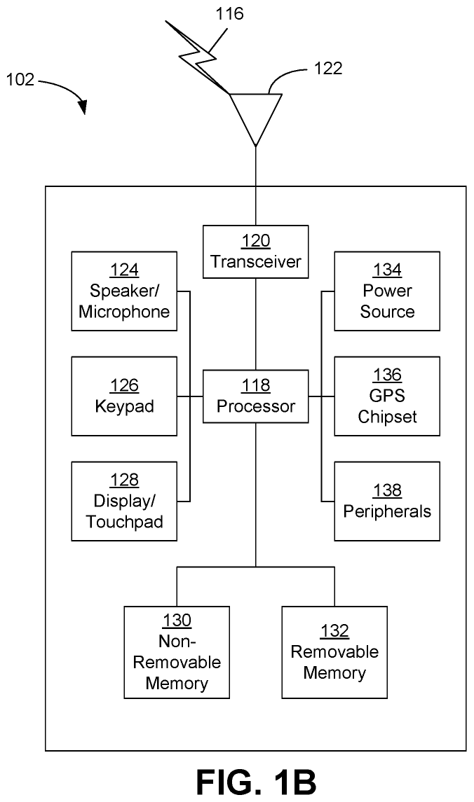

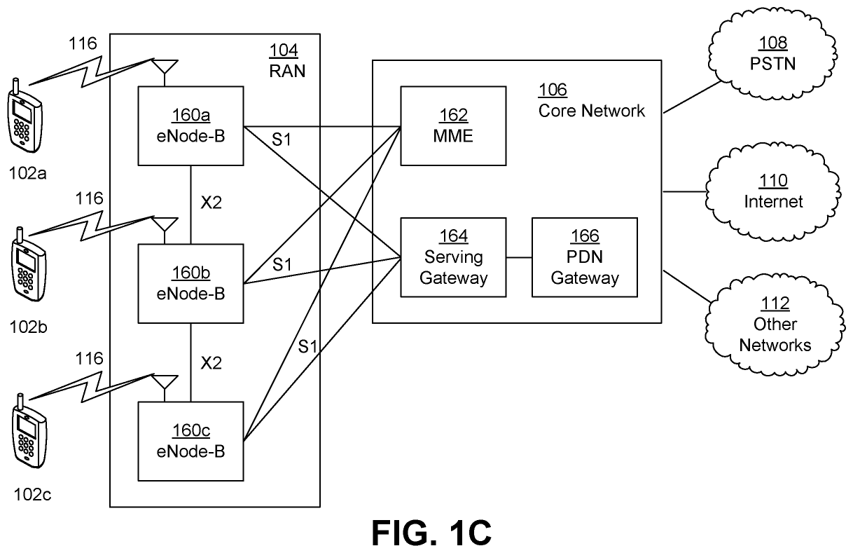

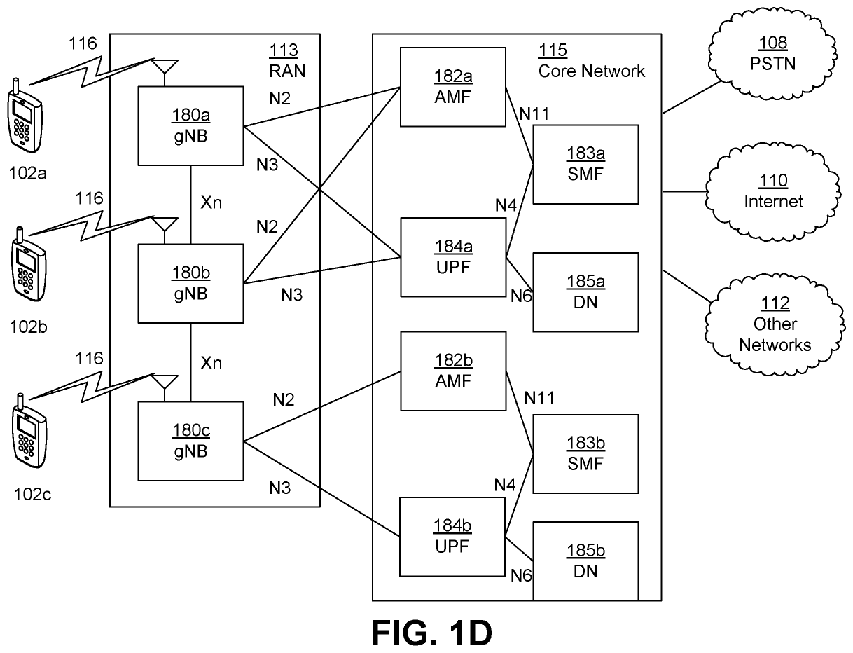

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHZ, and/or 160 MHz wide channels. The 40 MHZ, and/or 80 MHZ, channels may be formed by combining contiguous 20 MHZ channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As used herein, the term network may include application management function (AMF), location management function (LMF), base station (e.g., gNB), and/or next-generation radio access network (NG-RAN).

A WTRU may transmit or receive a physical channel or reference signal according to a (e.g., at least one) spatial domain filter. As described herein, the term “beam” may be used to refer to a spatial domain filter.

A WTRU may transmit a physical channel and/or signal a spatial domain filter. The spatial domain filter may be the same as the spatial domain filter used for receiving an RS (e.g., CSI-RS/SSB). The WTRU transmission may be referred to herein as “target”. The received RS and/or SS block may be referred to herein as “reference” and/or “source”. The WTRU may be said to transmit the target physical channel and/or signal according to a spatial relation with a reference to an RS and/or SS block.

A WTRU may transmit a first physical channel and/or signal according to the same spatial domain filter as the spatial domain filter used for transmitting a second physical channel and/or signal. The first and second transmissions may be referred to as “target” and “reference” (e.g., or “source”), respectively. The WTRU may be said to transmit the first (e.g., target) physical channel and/or signal according to a spatial relation with a reference to the second (e.g., reference) physical channel or signal.

A spatial relation may be implicit, configured by RRC, and/or signaled by MAC CE or DCI. For example, a WTRU may implicitly transmit PUSCH and/or DM-RS of PUSCH according to a similar (e.g., the same) spatial domain filter as a sounding reference signal (SRS) indicated by an SRI indicated in DCI or configured by RRC. In certain scenarios, the spatial relation may be configured by RRC, for example for an SRS resource indicator (SRI) and/or signaled by MAC CE for a PUCCH. A spatial relation may be referred to herein as a “beam indication”.

The WTRU may receive a first (e.g., target) downlink channel and/or signal according to a similar (e.g., the same) spatial domain filter or spatial reception parameter as a second (e.g., reference) downlink channel and/or signal. For example, an association may exist between a physical channel (e.g., PDCCH and/or PDSCH) and a respective DM-RS. If the first and second signals are reference signals for example, an association may exist when the WTRU is configured with a quasi-colocation (QCL) assumption type D between corresponding antenna ports. An association may be configured as a transmission configuration indicator (TCI) state. A WTRU may be provided with an indication of an association between a CSI-RS and/or SS block and a DM-RS, for example, by an index to a set of TCI states configured by RRC and/or signaled by MAC CE. An indication may be referred to herein as a “beam indication”.

As described herein, a transmission and reception point (TRP) may also refer to one or more of a transmission point (TP), a reception point (RP), a radio remote head (RRH), a distributed antenna (DA), a base station (BS), a sector (e.g., of a BS), and/or a cell (e.g., a geographical cell area served by a BS). As described herein, multi-TRP may refer to one or more of MTRP, M-TRP, and/or multiple TRPs.

A WTRU may report a subset of channel state information (CSI) components. CSI components may correspond to one or more of a CSI-RS resource indicator (CRI), a SSB resource indicator (SSBRI), an indication of a panel used for reception at the WTRU (e.g., such as a panel identity or group identity), one or more measurements, and/or any other (e.g., suitable) channel state information. The one or more measurements may include one or more of L1-RSRP, L1-SINR taken from SSB and/or CSI-RS (e.g. cri-RSRP, cri-SINR, ssb-Index-RSRP, ssb-Index-SINR). The other channel state information may include one or more of a least rank indicator (RI), a channel quality indicator (CQI), a precoding matrix indicator (PMI), a layer index (LI), and/or the like.

A WTRU may receive a synchronization signal/physical broadcast channel (SS/PBCH) block. The SS/PBCH block (SSB) may include one or more of a primary synchronization signal (PSS), secondary synchronization signal (SSS), and/or a physical broadcast channel (PBCH). The WTRU may monitor, receive, and/or attempt to decode an SSB. For example, the WTRU may monitor, receive, and/or attempt to decode an SSB during one or more of initial access, initial synchronization, radio link monitoring (RLM), cell search, cell switching, and/or the like.

A WTRU may measure and report the channel state information (CSI). One or more of the following may apply. CSI report configuration may be performed. A CSI report quantity may be configured. The CSI report quantity may include one or more of a Channel Quality Indicator (CQI), a Rank Indicator (RI), a Precoding Matrix Indicator (PMI), CSI-RS Resource Indicator (CRI), a Layer Indicator (LI), etc. A CSI report type may be configured. The CSI report type may include one or more of aperiodic, semi persistent, and/or periodic. A CSI report codebook may be configured. The CSI report codebook may include one or more of Type I, Type II, Type II port selection, etc. A CSI report frequency may be configured.

One or more settings associated with a CSI-RS resource set may be configured. For example, the one or more settings associated with a CSI-RS resource may include one or more of a non-zero power (NZP) CSI-RS resource for channel measurement, an NZP-CSI-RS Resource for interference measurement, and/or a CSI-IM resource for interference measurement. For example, the NZP CSI-RS resources may include one or more of a NZP CSI-RS resource ID, a periodicity and offset, a QCL Info and TCI-state, resource mapping (e.g., number of ports, density, code division multiplexing (CDM) type), etc.

A WTRU may indicate, determine, and/or be configured with one or more reference signals. The WTRU may monitor, receive, and/or measure one or more parameters based on the (e.g., respective) reference signals. For example, the parameters may include one or more of a SS-RSRP, a CSI-RSRP, a SS-SINR, a CSI-SINR, an RSSI, a CLI-RSSI; and/or an SRS-RSRP.

One or more of the following may apply. An SS reference signal received power (SS-RSRP) may be measured, for example based on the synchronization signals (e.g., demodulation reference signal (DMRS) in PBCH and/or SSS). The SS-RSRP may be defined as a linear average, for example over the power contribution of the resource elements (RE) that carries the respective synchronization signal. Power scaling for the reference signals may be performed, for example in measuring the RSRP. The measurement may be performed based on CSI reference signals and/or the synchronization signals, for example if a SS-RSRP is used for L1-RSRP.

A CSI-RSRP may be measured, for example based on the linear average over the power contribution of the resource elements (RE) that carry the respective CSI-RS. The CSI-RSRP measurement may be configured within measurement resources for the configured CSI-RS occasions.

An SS signal-to-noise and interference ratio (SS-SINR) may be measured, for example based on the synchronization signals (e.g., DMRS in PBCH or SSS). The SS-SINR may be defined as a linear average, for example over the power contribution of the resource elements (RE) that carry the respective synchronization signal divided by the linear average of the noise and interference power contribution. The noise and interference power measurement may be performed based on resources configured by higher layers, for example, if the SS-SINR is used for L1-SINR.

A CSI-SINR may be measured, for example, based on the linear average over the power contribution of the resource elements (RE) that carry the respective CSI-RS divided by the linear average of the noise and interference power contribution. The noise and interference power measurement may be performed based on resources configured by higher layers, for example if the CSI-SINR is used for L1-SINR. The noise and interference power may be measured based on the resources that carry the respective CSI-RS, for example if the CSI-SINR is not used for L1-SINR.

A received signal strength indicator (RSSI) may be measured, for example based on the average of the total power contribution in configured OFDM symbols and/or bandwidth. The power contribution may be received from different resources. For example, the power contribution may be received form one or more of co-channel serving and non-serving cells, adjacent channel interference, thermal noise, and so forth.

A cross-layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth)

Sounding reference signals RSRP (SRS-RSRP) may be measured, for example based on the linear average over the power contribution of the resource elements (RE) that carry the respective SRS.

A CSI report configuration (e.g., CSI-ReportConfigs) may be associated with a BWP (e.g., indicated by BWP-Id). For example, a CSI report configuration may be used to configure one or more of the following parameters: CSI-RS resources and/or CSI-RS resource sets for channel and interference measurement; CSI-RS report configuration type including the periodic, semi-persistent, and aperiodic; CSI-RS transmission periodicity for periodic and semi-persistent CSI reports; CSI-RS transmission slot offset for periodic, semi-persistent and/or aperiodic CSI reports; CSI-RS transmission slot offset list for semi-persistent and/or aperiodic CSI reports; time restrictions for channel and/or interference measurements; report frequency band configuration (e.g., wideband/subband CQI, PMI, etc.); thresholds and modes of calculations for the reporting quantities (e.g., CQI, RSRP, SINR, LI, RI, etc.); codebook configuration; group based beam reporting; CQI table; subband size; non-PMI port indication; port Index; and/or the like.

A CSI-RS Resource Set (e.g., NZP-CSI-RS-ResourceSet) may include one or more CSI-RS resources. For example, a CSI-RS resource set may include an NZP-CSI-RS-Resource and CSI-ResourceConfig. A WTRU may be configured with one or more of the following parameters for a given CSI-RS Resource: a CSI-RS periodicity and slot offset for periodic and/or semi-persistent CSI-RS Resources; CSI-RS resource mapping; the bandwidth part to which the configured CSI-RS is allocated; and/or the reference to the TCI-State. The CIS-RS resource mapping may be to define one or more of the number of CSI-RS ports, density, CDM-type, OFDM symbol, and/or subcarrier occupancy. The reference to the TCI-state include the QCL source RS(s) and/or the corresponding QCL type(s).

A WTRU may be configured with one or more RS resource sets. For example, the RS resource set configuration may include one or more of a RS resource set ID, one or more RS resources for the RS resource set, a repetition (e.g., on or off), an aperiodic triggering offset (e.g., one of 0-6 slots); and/or TRS information (e.g., true or false).

A WTRU may be configured with one or more RS resources. For example, the RS resource configuration may include one or more of a RS resource ID, a resource mapping (e.g., REs in a PRB), a power control offset (e.g., one value of −8, . . . , 15), a power control offset with SS (e.g., −3 dB, 0 dB, 3 dB, 6 Db), a scrambling ID, a periodicity and offset, and/or QCL information (e.g., based on a TCI state).

A property of a grant and/or assignment may include one or more of the following: a frequency allocation; an aspect of time allocation (e.g., a duration); a priority; a modulation and coding scheme (MCS); a transport block size; a number of spatial layers; a number of transport blocks; a TCI state, CRI and/or SRI; a number of repetitions; whether the repetition scheme is Type A or Type B; whether the grant is a configured grant type 1, type 2, and/or a dynamic grant; whether the assignment is a dynamic assignment and/or a semi-persistent scheduling (e.g., configured) assignment; a configured grant index and/or a semi-persistent assignment index; a periodicity (e.g., of a configured grant and/or assignment); a channel access priority class (CAPC); and/or a (e.g., any) parameter provided in a DCI, by MAC and/or by RRC for the scheduling the grant and/or assignment.

An indication by DCI may include one or more of an explicit indication by a DCI field or by RNTI (e.g., used to mask CRC of the PDCCH), and/or an implicit indication by a property. The implicit indication by the property may include one or more of a DCI format, a DCI size, a Coreset and/or search space, an aggregation level, and/or a first resource element of the received DCI (e.g., index of first CCE). A mapping between the property and the value may be signaled by RRC and/or MAC.

RS may refer to one or more of an RS resource, an RS resource set, an RS port, and/or an RS port group. RS may additionally or alternatively refer to one or more of an SSB, a CSI-RS, an SRS, a DM-RS, a TRS, a PRS, and/or a PTRS. RS may additionally or alternatively refer to one or more of a sounding reference signal (SRS), a Channel state information-reference signal (CSI-RS), a Demodulation reference signal (DM-RS), a Phase tracking reference signal (PT-RS), and/or a Synchronization signal block (SSB). A channel may refer to one or more of a PDCCH, a PDSCH, a Physical uplink control channel (PUCCH), a Physical uplink shared channel (PUSCH), a Physical random access channel (PRACH), and/or the like. Additionally, or alternatively, a RS resource set may refer to a RS resource and/or a beam group. Beam reporting may refer to one or more of a CSI measurement, CSI reporting, and/or beam measurement. The techniques described herein associated with beam resource prediction may additionally, or alternatively, be used for beam resources belonging to a one or more cells, as well one or more TRPs.

Beam management (BM) may be performed. For example, beam management (e.g., in NR) may be based on a hierarchical beam searching principle. For example, a WTRU may (e.g., first) select a preferred wide beam from a set of wide beams (e.g., SSB) and/or feedback the selected SSB to a gNB (e.g., via a PRACH transmission in the initial access stage). The gNB may transmit one or more (e.g., a plurality) refined beams, for example based on the selected SSB as the initial spatial information. The refined beams may be transmitted with a CSI reporting configuration. The CSI reporting configuration may be used to measure and feedback a preferred beam, for example a refined narrow beam, to a gNB.

BM may be categorized into P-1, P-2, and/or P-3 procedures, for example in NR networks. A P-1 procedure may be used to enable WTRU measurements, for example on different Tx beams and/or to support selection of Tx beams/WTRU Rx beam(s). A P-1 may, for example, be based on a wide beam search (e.g., to determine the optimal receive beam). The WTRU may select a suitable SSB for UL transmission (e.g., according to DL measurements). A P-2 procedure may be used, for example to enable WTRU measurement on different Tx beams (e.g., to change inter/intra Tx beam(s). A P-2 procedure may be based on a gNB configuring a set of CSI-RS resource sets. For example, each CSI-RS resource set may have one or more (e.g., multiple) resources. The WTRU may use the one or more resources to perform measurement(s) for beam refinement and/or to select a refined beam. The gNB may determine a refined beam for downlink and uplink reception, for example, based on the WTRU's downlink measurement on a gNB's one or more Tx refined beams. A P-3 procedure may be used, for example to enable WTRU measurement on the same Tx beam. Measurement on the same Tx beam may be performed to change the WTRU Rx beam (e.g., if the WTRU uses beamforming). The WTRU may determine a WTRU Tx beam for the uplink transmission, for example based on a WTRU downlink measurement on the one or more Rx beams associated with the WTRU. The gNB may repeat refined beams for WTRU to perform measurement(s).

L1-RSRP (e.g., CRI-RSRP, SSB-index-RSRP) may be used during BM procedures, for example, in NR networks. L1-RSRP (e.g., CRI-RSRP, SSB-index-RSRP) may be used during BM procedures to identify a downlink beam, for example the best downlink beam. An SSB-Index-RSRP may include an RSRP measurement and/or reporting, for example based on SSB (e.g., with different beams). CRI-RSRP may include an RSRP measurement and/or reporting, for example based on CSI-RS resources (e.g., with different beams).

Beam selection techniques may be based on beam sweeping at gNB-side and/or the WTRU-side. Beam selection techniques may result in beam sweeping and/or measurement(s) over a number (e.g., a large number) of antennas at gNB and WTRU side (e.g., especially for large number of antennas, high frequencies, etc.). The WTRU may report one or more beams in a beam management procedure. For example, upon selection of the best beams, the WTRU may report up to four beams (e.g., based on RSRP) in a beam management procedure. The WTRU may report the one or more beams in an NR network.

Artificial Intelligence/Machine Learning (AI/ML) techniques may be provided. For example, Artificial intelligence may be behavior exhibited by machines that may, for example, mimic cognitive functions to sense, reason, adapt and act, and/or the like. Machine learning may refer to types of algorithms that are based on learning through experience (e.g., data), for example without being programmed (e.g., configuring a set of rules). Machine learning may be a subset of AI. Different machine learning paradigms may be utilized, for example based on the nature of the data and/or feedback available to the learning algorithm. For example, a supervised learning approach may involve learning a function that maps input to an output, for example, based on labeled training example. Each training example may include a pair which includes an input and a corresponding output. An unsupervised learning approach may involve detecting patterns in the data, for example without pre-existing labels. A reinforcement learning approach may involve performing a sequence of actions in an environment, for example to maximize a cumulative reward. Machine learning algorithms may be applied using a combination and/or interpolation of the approaches disclosed herein. For example, a semi-supervised learning approach may use a combination of an amount of labeled data with an amount of unlabeled data during training. Semi-supervised learning may be between unsupervised learning (e.g., with no labeled training data) and supervised learning (e.g., with only labeled training data). For example, semi-supervised learning may include a hybrid of unsupervised learning (e.g., with no labeled training data) and supervised learning (e.g., with only labeled training data).

Deep learning (DL) may refer to a class of machine learning algorithms that include artificial neural networks (e.g., specifically DNNs). Artificial neural networks may be based on biological systems. Deep Neural Networks (DNNs) may include a class of machine learning models that are based on the human brain. Input may be linearly transformed and/or passed-through a non-linear activation function one or more (e.g., multiple) times, for example in a DNN. DNNs may include one or more (e.g., multiple) layers, where, for example, each layer may include a linear transformation and/or a given non-linear activation function. The DNNs may be trained using the training data, for example, via a back-propagation algorithm. DNNs may show state-of-the-art performance in a variety of domains, for example in one or more of speech, vision, natural language, etc., and/or for various machine learning settings supervised, un-supervised, and/or semi-supervised. As herein, the term AI/ML based methods/processing may refer to the realization of behaviors and/or learning based on data, for example without configuration (e.g., explicit configuration) of a sequence of steps or actions. Methods (e.g., these methods) may enable learning complex behaviors.

The devices and/or functions may use AI/ML, for example to predict and/or refine beam pairs and associated quality metrics. As used herein, the term “machine learning” and/or “ML” may refer to a type of algorithms that solve a problem based on learning through experience (“data”), without explicitly being preprogrammed with a configuring set of rules. Machine learning can be considered as a subset of AI. Different machine learning paradigms may be envisioned based on the nature of data and/or feedback available to the learning algorithm. For example, a supervised learning approach may involve learning a function that maps input to an output based on labeled training example, where one or more (e.g., each) training example may be a pair including input and the corresponding output. An unsupervised learning approach may involve detecting patterns in the data without pre-existing labels. A reinforcement learning approach may involve performing sequence of actions in an environment to maximize the cumulative reward. In examples, it may be possible to apply one or more machine learning algorithms using a combination and/or interpolation of the approaches mentioned herein (e.g., above-mentioned approaches). For example, a semi-supervised learning approach may use a combination of a small amount of labeled data with a large amount of unlabeled data during training. In this regard, semi-supervised learning may fall between unsupervised learning (e.g., without labeled training data) and supervised learning (e.g., with labeled training data).

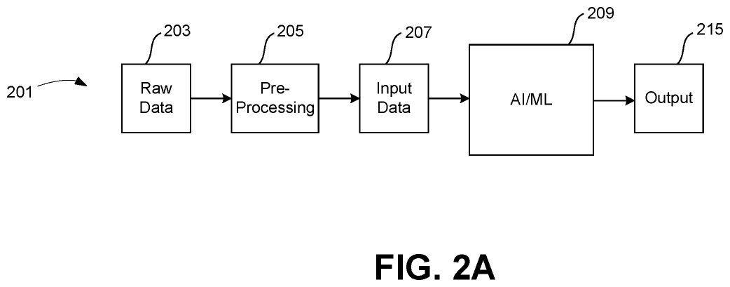

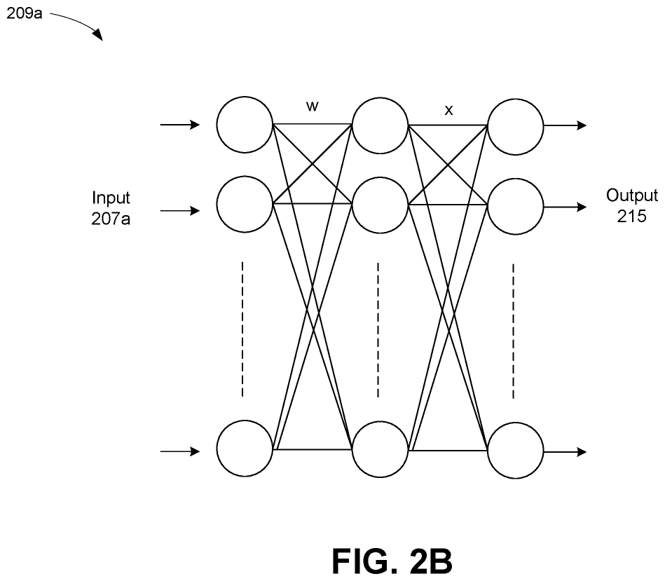

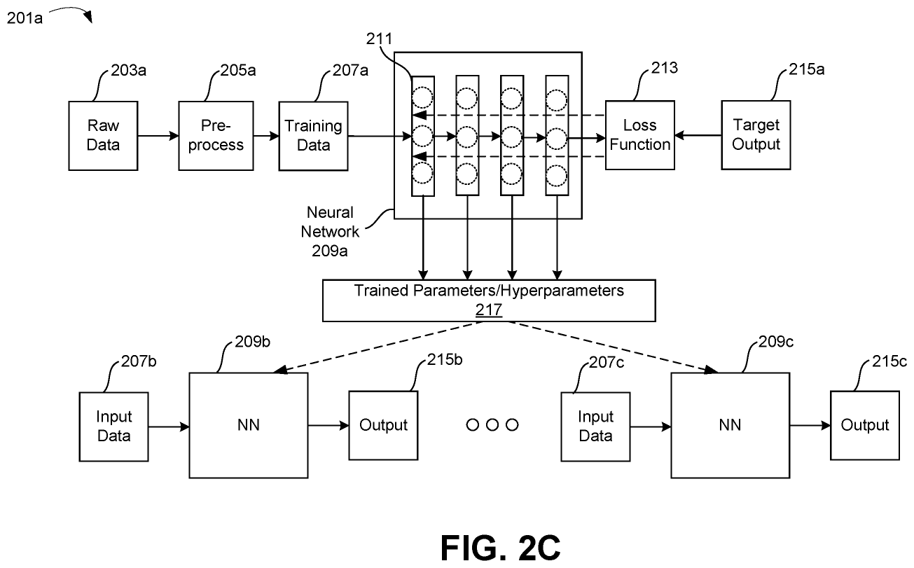

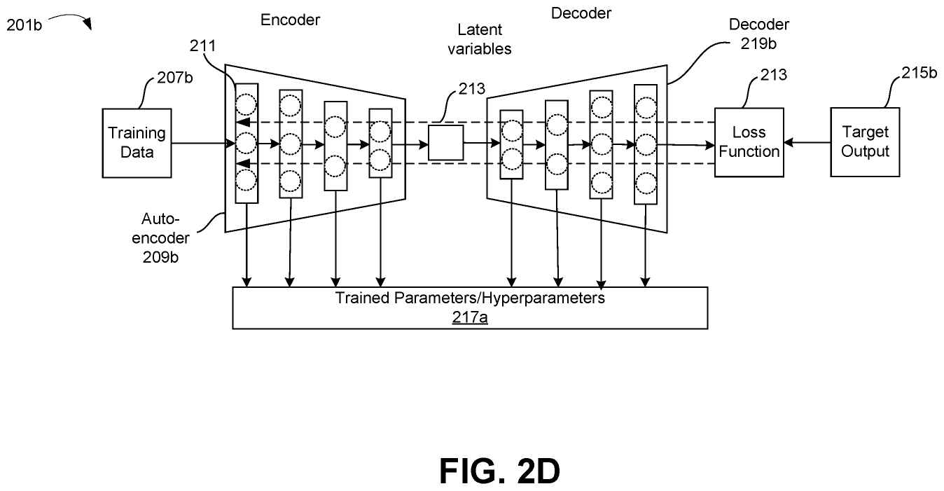

FIG. 2A is a schematic illustration of an example system environment 201 that may implement an AI/ML 209 model. The AI/ML model 209 may be implemented at the WTRU and/or the network. The AI/ML 209 model may include model data and one or more algorithms and/or functions configured to learn from input data 207 that is received to train the AI/ML 209 and/or generate an output 215. The input data 207 may be input in one or more formats, such as an image format, an audio format (e.g., spectrogram or other audio format), a tensor format (e.g., including single-dimensional or multi-dimensional arrays), and/or another data type capable of being input into the AI/ML 209 algorithms. The input data 207 may be the result of pre-processing 205 that may be performed on raw data 203, or the input data 207 may include the raw data 203 itself. The raw data 203 may include image data, text data, audio data, or another sequence of information, such as a sequence of network information related to a communication network, and/or other types of data. The pre-processing 205 may include format changes or other types of processing in order to generate input data 207 in a format for being input into the AI/ML 209 algorithms. The output 215 may be generated by the AI/ML 209 algorithm in one or more formats, such as a tensor, a text format (e.g., a word, sentence, or other sequence of text), a numerical format (e.g., a prediction), an audio format, an image format (e.g., including video format), another data sequence format, or/another output format. As described herein, the output 215 may include one or more of predicted beam pairs, predicted measurements for the one or more beam-pairs based on the stored training data samples and a predictive beam refinement configuration, predictive beam identifiers, codebook identifiers, predictive layer 1 received signal received power (L1-RSRP) values, and/or predictive angle of arrival (AoA), for example based on the predicted measurements.

AI/ML 209 may be implemented as described herein using software and/or hardware. The AI/ML 209 may be stored as computer-executable instructions on computer-readable media accessible by one or more processors for performing as described herein. Example AI/ML environments and/or libraries include TENSORFLOW, TORCH, PYTORCH, MATLAB, GOOGLE CLOUD AI and AUTOML, AMAZON SAGEMAKER, AZURE MACHINE LEARNING STUDIO, and/or ORACLE MACHINE LEARNING.

The AI/ML 209 may include one or more algorithms configured for unsupervised learning. Unsupervised learning may be implemented utilizing AI/ML 209 algorithms that learn from the input data 207 without being trained toward a particular target output. For example, during unsupervised learning the AI/ML 209 algorithms may receive unlabeled data as input data 207 and determine patterns or similarities in the input data 207 without additional intervention (e.g., updating parameters and/or hyperparameters). The AI/ML 209 algorithms that are configured for implementing unsupervised learning may include algorithms configured for identifying patterns, groupings, clusters, anomalies, and/or similarities or other associations in the input data 207. For example, the AI/ML may implement hierarchical clustering algorithms, k-means clustering algorithms, k nearest neighbors (K-NN) algorithms, anomaly detection algorithms, principal component analysis algorithms, and/or apriori algorithms. The AI/ML 209 algorithms configured for unsupervised learning may be implemented on a single device or distributed across multiple devices, such that the output 215, or portions thereof, may be aggregated at one or more devices for being further processed and/or implemented in other downstream algorithms or processes, as may be further described herein.

The AI/ML 209 may include one or more algorithms configured for supervised learning. Supervised learning may be implemented utilizing AI/ML 209 algorithms that are trained during a training process to determine a predictive model using known outcomes. The AI/ML 209 algorithms may be characterized by parameters and/or hyperparameters that may be trained during the training process. The parameters may include values derived during the training process. The parameters may include weights, coefficients, and/or biases. The AI/ML 209 may also include hyperparameters. The hyperparameters may include values used to control the learning process. The hyperparameters may include a learning rate, a number of epochs, a batch size, a number of layers, a number of nodes in each layer, a number of kernels (e.g., CNNs), a size of stride (e.g., CNNs), a size of kernels in a pooling layer (e.g., CNNs), and/or other hyperparameters. Some may use certain parameters and hyperparameters interchangeably.

The AI/ML 209 may be trained during supervised learning by inputting training data to the AI/ML 209 algorithm and adjusting the parameters and/or hyperparameters toward a known target output 215 while minimizing a loss or error in the output 215 generated by the AI/ML 209 algorithm. The raw data 203 may include or be separated into training data, validation data, and/or test data for training, validation, and/or testing, respectively, the AI/ML 209 algorithms during supervised learning. The training data, validation data, and/or test data may be pre-processed from the raw data 203 for being input into the AI/ML 209 algorithm. During supervised learning, the training data may be labeled prior to being input into the AI/ML 209. The training data may be labeled to teach the AI/ML 209 algorithm to learn from the labeled data and to test the accuracy of the AI/ML 209 for being implemented on unlabeled input data 207 during production/implementation of the AI/ML 209 algorithms, or similar AI/ML 209 algorithms utilizing similar parameters and/or hyperparameters. The training data may be used to fit the parameters of the AI/ML 209 model using optimization functions, such as a loss or error function. Often the training data includes pairs of input data 207 and a corresponding target output 215 to which the parameters may be trained to generate (e.g., within a threshold loss or error). The trained or fitted AI/ML 209 model may receive the validation data as input to evaluate the model fit on the training data set, while tuning the hyperparameters of the AI/ML 209 model. The AI/ML 209 model may receive the test data to evaluate a final model fit on the training data set and to assess the performance of the AI/ML 209 model. One or more of the training, validation, and/or testing may be performed during supervised learning for different types of AI/ML 209 models.

Supervised learning may be implemented for various types of AI/ML 209 algorithms, including algorithms that implement linear regression, logistic regression, neural networks (NNs), decision trees, Bayesian logics, random forests, and/or support vector machines (SVMs). NNs and Deep NNs (DNNs) are popular examples of algorithms utilized in AI/ML models that may be trained using supervised learning. However, the AI/ML 209 models may implement one or more NN and/or non-NN-based algorithms. Various examples of NNs include: perceptrons, multilayer perceptrons (MLPs), feed-forward NNs, fully-connected NNs, convolutional Neural Networks (CNNs), recurrent NNs (RNNs), long-short term memory (LSTM) NNs, and/or residual NNs (ResNets). A perceptron is a NN that includes a function that multiplies its input by a learned weight coefficient to generate an output value. A feed-forward NN is a NN that receives input at one or more nodes of an input layer and moves information in a direction through one or more hidden layers to one or more nodes of an output layer. In a feed-forward NN, one or more nodes of a given layer may be connected to one or more nodes of another layer. A fully connected NN is a NN that includes an input layer, one or more hidden layers, and an output layer. In a fully connected NN, each node in a layer is connected to each node in another layer of the NN. An MLP is a fully connected class of feed-forward NNs. A CNN is a NN having one or more convolutional layers configured to perform a convolution. Various types of NNs may have elements that include one or more CNNs or convolutional layers, such as Generative Adversarial Networks (GANs). GANs may include conditional GANs (CGANs), cycle-consistent GANs (CycleGANs), StyleGANs, DiscoGANs, and/or IsGANs. A GAN may include a generator sub-model and a discriminator sub-model. The generator sub-model may be configured to receive input data and pass true and independently generated data to the discriminator sub-model. The discriminator sub-model may be configured to receive the true and independently generated data from the generator, discriminate the true and independently generated data, and provide feedback to the generator sub-model during training to improve the function of the generator sub-model in independently generating an output based on a received input. The GAN is a popular model for generating data types or data sequences, such as image data, audio data, and/or text, for example. An RNN is a NN that is recurrent in nature, as the nodes include feedback connections and an internal hidden state (e.g., memory) that allows output from nodes in the NN to affect subsequent input to the same nodes. LSTM NNs may be similar to RNNs in that the nodes have feedback connections and an internal hidden state (e.g., memory). However, the LSTM NNs may include additional gates to allow the LSTM NNs to learn longer-term dependencies between sequences of data. A ResNet is a NN that may include skip connections to skip one or more layers of the NN. An autoencoder may be a form of AI/ML 109 that may be implemented for supervised learning, such that parameters and/or hyperparameters may be updated during a training procedure. The parameters and/or hyperparameters may relate to the encoder portion and/or the decoder portion of the autoencoder. Some NNs include one or more attention layers or functions to enhance or focus on some portions of the input data, while diminishing or de-emphasizing other portions.

Different types of NNs and/or layers may be implemented for processing different types of data and/or producing different types of output. For example, the NN may comprise one or more convolutional layers (e.g., for CNNs or GANs), which may be popular for processing image data and/or audio data (e.g., spectrograms). Each convolutional layer may vary according to various convolutional layer parameters or hyperparameters, such as kernel size (e.g., field of view of the convolution), stride (e.g., step size of the kernel when traversing an image), padding (e.g., for processing image borders), and/or input and output size. The image being processed may include one or more dimensions (e.g., a line of pixels or a two-dimensional array of pixels). The pixels may be represented according to one or more values (e.g., one or more integer values representing color and/or intensity) that may be received by the convolutional layer. The kernel, which may also be referred to as a convolution matrix or mask, may be a matrix used to extract and/or transform features from the input data being received. The kernel may be used for blurring, sharpening, edge detection, and/or the like. An example kernel size may include a 3×3, 5×5, 10×10, etc. matrix (e.g., in pixels for a 2D image). The stride may be the parameter used to identify the amount the kernel is moved over the image data. An example default stride is of a size of 1 or 2 within the matrix (e.g., in pixels for a 2D image). The padding may include the amount of data (e.g., in pixels for a 2D image) that is added to the boundaries of the image data when it is processed by the kernel. The kernel may be moved over the input image data (e.g., according to the stride length) and perform a dot product with the overlapping input region to obtain an activation value for the region. The output of each convolutional layer may be provided to a next layer of the NN or provided as an output (e.g., image data, feature map, etc.) of the NN itself with the updated features based on the convolution.

The NN may include layers of a similar type (e.g., convolutional layers, feed-forward layers, fully-connected layers, etc.) and/or having a similar or different configuration (e.g., size, number of nodes, etc.) for each layer. The NN may also, or alternatively, include one or more layers having different types or different subsets of NNs that may be interconnected for training and/or implementation, as described herein. For example, a NN may include both convolutional layers and feed-forward or fully-connected layers.

FIG. 2B illustrates an example of a neural network 209a. The objective of training may be to apply the input 207a as training data and/or adjust one or more weights, indicated as w and x in FIG. 2B (e.g., which may be referred to as neuron weights and/or link weights), such that the output 215 from the neural network 209a approaches the desired target values which are associated with the input 207a values for the training data. In examples, a neural network may include three layers (e.g., as shown in FIG. 2B). During the training, for given input, the difference between output and desired values may be computed and/or the difference may be used to update the one or more weights in the neural network. If a significant (e.g., large) difference between output and desired value(s) is observed, for example, one or more relatively significant (e.g., large) changes in one or more weights may be expected. A small difference (e.g., between output and desired value(s) may include one or more relatively small changes in one or more weights. For example, for positioning, the input 207a may be reference signal parameters and/or the output 215 may be an estimated position. The desired value may be location information acquired by global navigation satellite system (GNSS) with high accuracy.

Once the neural network 209a completes its training, the difference between the output 215 and desired values may be below a threshold. The neural network 209a may be applied or implemented after training for positioning by feeding input data 207a and/or by estimating or predicting the output 215 as the expected outcome for the associated input 207a. The output 215 may be an estimated position and/or location of the WTRU.

Training a neural network 209a may include identifying one or more of the following information: the input for the neural network; the expected output associated with the input; and/or the actual output from the neural network against which the target values are compared.

In examples, a neural network model may be characterized by one or more parameters and/or hyperparameters, which may include: the number of weights and/or the number of layers in the neural network.

As used herein, the term “deep learning” may refer to a class of machine learning algorithms that employ artificial neural networks (e.g., deep neural networks (DNNs)) which were loosely inspired from biological systems and/or include at least one hidden layer. DNNs may be a special class of machine learning models inspired by the human brain where the input is linearly transformed and/or pass through a non-linear activation function one or more (e.g., multiple) times. DNNs may include one or more (e.g., multiple) layers where one or more (e.g., each) layer includes linear transformation and/or a given non-linear activation function(s). The DNNs may be trained using the training data via a back-propagation algorithm. Recently, DNNs have shown state-of-the-art performance in variety of domains, e.g., speech, vision, natural language etc., and/or for various machine learning settings (e.g., supervised, unsupervised, and/or semi-supervised).

FIG. 2C is a schematic illustration of an example system environment 201a for training and implementing an AI/ML model that comprises an NN 209a. However, other types of AI/ML models (e.g., including NNs and/or non-NN models) may be similarly trained and/or implemented. The NN 209a may be trained and/or implemented on one or more devices to determine and/or update parameters and/or hyperparameters 217 of the NN 209a. Raw data 203a may be generated from one or more sources. For example, the raw data 203a may include image data, text data, audio data, or another sequence of information, such as a sequence of network information related to a communication network, and/or other types of data. The raw data 203a may be preprocessed at 205a to generate training data 207a. The preprocessing may include formatting changes or other types of processing in order to generate the training data 207a in a format for being input into the NN 209a.

The NN 209a may include one or more layers 211. The configuration of the NN 209a and/or the layers 211 may be based on the parameters and/or hyperparameters 217. As described herein, the parameters may include weights, or coefficients, and/or biases for the nodes or functions in the layers 211. The hyperparameters may include a learning rate, a number of epochs, a batch size, a number of layers, a number of nodes in each layer, a number of kernels (e.g., CNNs), a size of stride (e.g., CNNs), a size of kernels in a pooling layer (e.g., CNNs), and/or other hyperparameters. As described herein, the NN 109a may include a feed forward NN, a fully connected NN a CNN, a GAN, an RNN, a ResNet, and/or one or more other types of NNs. The NN 209a may be comprised of one or more different types of NNs or different layers for different types of NNs. For example, the NN 109a may include one or more individual layers having one or more configurations.

During the training process, the training data 207a may be input into the NN 209a and may be used to learn the parameters and/or tune the hyperparameters 217. The training may be performed by initializing parameters and/or hyperparameters of the NN 209a, generating and/or accessing the training data 207a, inputting the training data 207a into the NN 209a, calculating the error or loss from the output of the NN 209a to a target output 215a via a loss function 213 (e.g., utilizing gradient descent and/or associated back propagation), and/or updating the parameters and/or hyperparameters 217.

The loss function 213 may be implemented using backpropagation-based gradient updates and/or gradient descent techniques, such as Stochastic Gradient Descent (SGD), synchronous SGD, asynchronous SGD, batch gradient descent, and/or mini-batch gradient descent. Examples of loss or error functions may include functions for determining a squared-error loss, a mean squared error (MSE) loss, a mean absolute error loss, a mean absolute percentage error loss, a mean squared logarithmic error loss, a pixel-based loss, a pixel-wise loss, a cross-entropy loss, a log loss, and/or a fiducial-based loss. The loss functions may be implemented in accordance one or more quality metrics, such as a Signal to Noise Ratio (SNR) metric or another signal or image quality metric.

An optimizer may be implemented along with the loss function 213. The optimizer may be an algorithm or function that is configured to adapt attributes of the NN 209a, such as a learning rate and/or weights, to improve the accuracy of the NN 209a and/or reduce the loss or error. The optimizer may be implemented to update the parameters and/or hyperparameters 217 of the NN 209a.

The training process may be iterated to update the parameters and/or hyperparameters 217 until an end condition is achieved. The end condition may be achieved when the output of the NN 209a is within a predefined threshold of the target output 215a.

After the training process is complete, the trained NN 209a, or portions thereof, may be stored for being implemented by one or more devices. The trained NN 209a, or portions thereof, may be implemented in other downstream algorithms or processes, as may be further described herein. The trained NN 209a, or portions thereof, may be implemented on the same device on which the training was performed. The trained NN 209a, or portions thereof, may be transmitted or otherwise provided to another device for being implemented. For example, the NN 209b, 209c may include one or more portions of the trained NN 209a. The NN 209b and NN 209c receive respective input data 207b, 207c and generate respective outputs 215b, 215c. The output 215b, 215c may be generated in one or more formats, such as a tensor, a text format (e.g., a word, sentence, or other sequence of text), a numerical format (e.g., a prediction), an audio format, an image format (e.g., including video format), another data sequence format, and/or another output format. The output 215b, 215c may be aggregated at one or more devices for being further processed and/or implemented in other downstream algorithms or processes, as may be further described herein.

Alternatively, or additionally, after the training process is complete, the trained parameters and/or tuned hyperparameters 217, or portions thereof, may be stored for being implemented by one or more devices. The trained parameters and/or tuned hyperparameters 217, or portions thereof, may be implemented in other downstream algorithms or processes, as may be further described herein. The trained parameters and/or tuned hyperparameters 217, or portions thereof, may be implemented on the same device on which the training was performed. The trained parameters and/or tuned hyperparameters 217, or portions thereof, may be transmitted or otherwise provided to another device for being implemented. For example, transmitted or otherwise provided to another device or devices that may implement the NN 209b, 209c based on the trained parameters and/or tuned hyperparameters 217. For example, the NN 209b, 209c may be constructed at another device based on the trained parameters and/or tuned hyperparameters 217, or portions thereof. The NN 209b and NN 209c may be configured from the parameters/hyperparameters 217, or portions thereof, to receive respective input data 207b, 207c and to generate respective outputs 215b, 215c. The output 215b, 215c may be generated in one or more formats, such as a tensor, a text format (e.g., a word, sentence, or other sequence of text), a numerical format (e.g., a prediction), an audio format, an image format (e.g., including video format), another data sequence format, and/or another output format. The output 215b, 215c may be aggregated at one or more devices for being further processed and/or implemented in other downstream algorithms or processes, as may be further described herein.

The AI/ML models and/or algorithms described herein may be implemented on one or more devices. For example, the AI/ML 209 may be implemented in whole or in part on one or more devices, such as one or more WTRUs, one or more base stations, and/or one or more other network entities, such as a network server. Example networks in which AI/ML may be distributed may include federated networks. A federated network may include a decentralized group of devices that each include AI/ML. As shown in FIG. 2C, the AI/ML 209b and AI/ML 209c may be distributed across separate devices. Though FIG. 2C shows two models (e.g., AI/ML 209b and AI/ML 209c), any number of models may be implemented across any number of devices. The AI/ML may be implemented for collaborative learning in which the AI/ML is trained across multiple devices. In another example, the AI/ML may be trained at a centralized location or device and one or more portions of the AI/ML, or trained parameters and/or tuned hyperparameters, may be distributed to decentralized locations. For example, updated parameters or hyperparameters may be sent to one or more devices for updating and/or implementing the AI/ML thereon.

FIG. 2D is a schematic illustration of an example system environment 201b for training and/or implementing an AI/ML model that includes an auto-encoder. An Auto-encoder (AE) 209a may include one of more DNNs 211. For example, the AE 209a may include a class of DNNs 211 that arise in context of an un-supervised machine learning setting. Data (e.g., high-dimensional data) 207b may be (e.g., non-linearly) transformed to a lower dimensional latent vector, for example, using a DNN based encoder. A lower dimensional latent vector may be used to re-produce the high-dimensional data, for example using a non-linear decoder. The encoder may be represented as E (x; Wₑ), where x may be the high-dimensional data and Wₑ may represent the parameters of the encoder. The decoder 219b may be represented as D (z; W_{d}), where z may be the low-dimensional latent representation and W_{d} may represent the parameters of the decoder. Using training data 207b {x₁, . . . , x_{N}}, for example, the auto-encoder may be trained. For example, the auto-encode may be trained using Equation (1) below:

$$\{ {W}_{e}^{tr} , {W}_{d}^{tr} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} .$$

Equation (1) may be solved (e.g., approximately solved), for example, using a backpropagation algorithm. The trained encoder

$$E ( x ; {W}_{e}^{tr} )$$

may be used to compress the high-dimensional data, and trained decoder

$$D ( z ; {W}_{d}^{tr} )$$

may be used to decompress the latent representation. The auto-encoder 209b may be trained and/or implemented on one or more devices to determine and/or update parameters and/or hyperparameters 217 of the NN 209a. The training data 207b may include measurement(s), for example RS measurements. The target output 215b may include one or more of predicted beam pairs, predicted measurements for the one or more beam-pairs based on the stored training data samples and a predictive beam refinement configuration, predictive beam identifiers, codebook identifiers, predictive layer 1 received signal received power (L1-RSRP) values, and/or predictive angle of arrival (AoA), for example based on the predicted measurements. The training data may be associated with a wider beam or beam pair. The output may be associated with a narrower beam or beam pair.

As described herein, the terms Artificial Intelligence (AI), Machine Learning (ML), Deep Learning (DL), DNNs may be used interchangeably. Although the techniques described herein are exemplified based on learning in wireless communication systems, they may additionally, or alternatively, be used in other systems, including, for example, any type of transmissions, communication systems and/or services, etc.

Artificial Intelligence (AI)/Machine Learning (ML) for air interface (e.g., in NR) may be implemented. For example, AI/ML may be used in relation to beam management, including beam prediction in the time and/or spatial domain (e.g., for overhead and latency reduction), beam selection accuracy improvement, and/or the like.

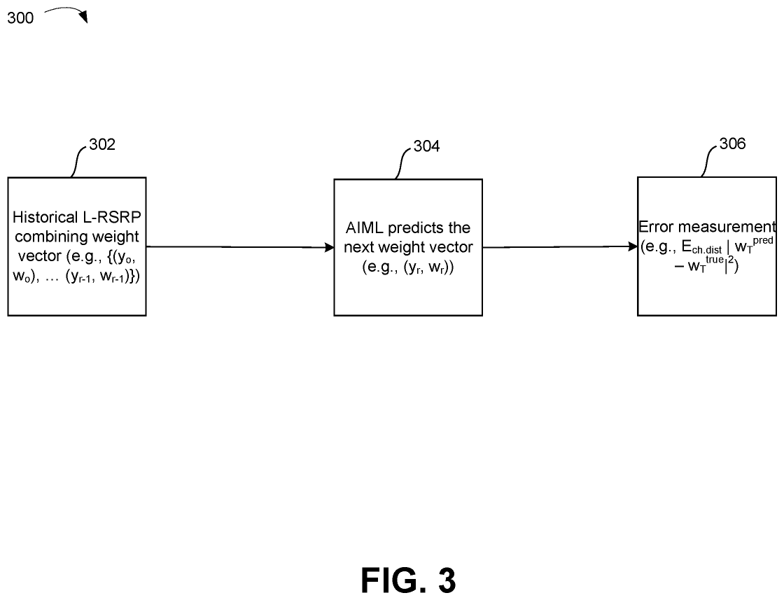

FIG. 3 is a schematic illustration of an example system 300 for training an AI/ML model. At 302 training data may be input. The training data may include historical L-RSRP combining weight vector(s). At 304 the AI/ML may predict the next weight vector, for example based on the training data. At 306 the system may output an error measurement. For example, the training data may include one or more measurements of a reference signal set.

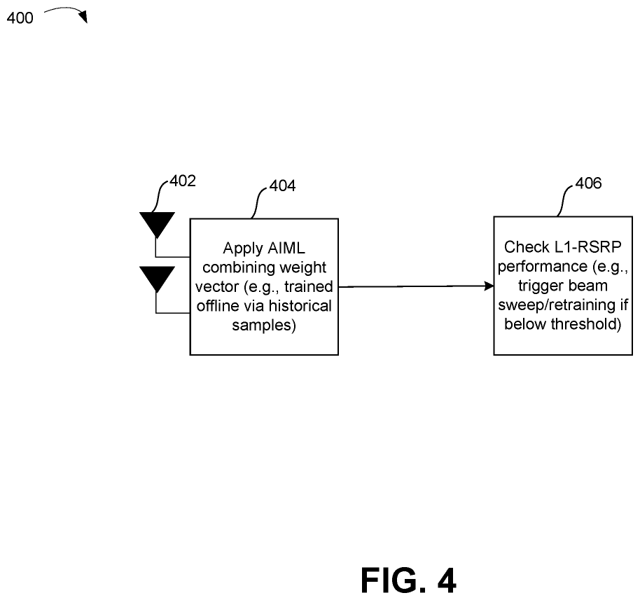

FIG. 4 is a schematic illustration of an example system 400 for inferring beam prediction performance. At 402 a beamformed signal may be received. At 404 AI/ML combining weight vector(s) may be applied. For example, the combining weight vector(s) may be trained offline via historical samples. At 406 the WTRU and/or a network entity may check L1-RSRP performance. A beam sweep and/or retraining (e.g., further training) may be triggered, for example if the L1-RSRP is below a threshold.

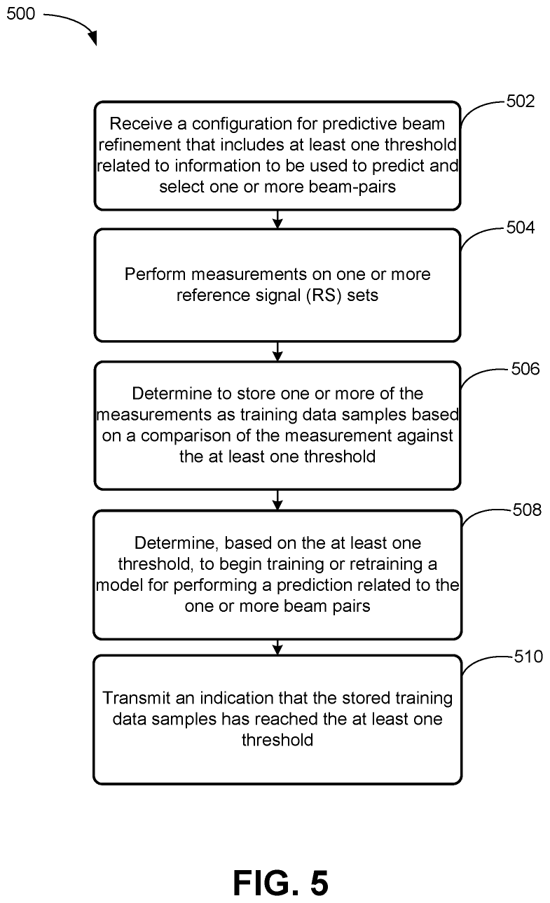

FIG. 5 is an example illustration of a procedure 500 for predictive beam refinement. At 502 a WTRU may receive a configuration for predictive beam refinement that includes at least one threshold related to information to be used to predict and select a beam-pair. At 504, the WTRU may perform a measurement on the reference signal (RS) set. At 506, the WTRU may determine to store the measurement as a training data sample in a memory. The WTRU may determine to store one or more measurements based on a comparison of the measurement against the at least one threshold. At 508, the WTRU may determine, for example based on the at least one threshold, to begin training or retraining a model for performing a prediction related to the one or more beam pairs. At 510, the WTRU may transmit an indication that the stored training data samples have reached the at least one threshold.

The WTRU may predict measurements, for example for the one or more beam-pairs. For example, the WTRU may predict measurements based on the stored training data samples and/or a predictive beam refinement configuration. The WTRU may report one or more of predictive beam identifiers, codebook identifiers, predictive layer 1 received signal received power (L1-RSRP) values, or predictive angle of arrival (AoA), for example based on the predicted measurements. The at least one threshold may include at least one of a buffer size threshold related to the memory for indicating a maximum number of samples of beam quality measurement or beam combining weight pairs, a threshold related to a maximum buffer size or remaining buffer size, a threshold related to one or more measurements to be performed on one or more RS sets, a threshold number of comparisons of one or more measurements against one or more thresholds, an AI/ML model being completed, and/or one or more thresholds to determine to store a sample in the memory.

The determination to begin predicting measurements for the one or more beam-pairs may be made at the WTRU and/or at a network entity. The at least one threshold may be related to the information to be used to predict and/or select the one or more beam-pairs.

The WTRU may store the one or more of the measurements as training data samples in the memory, for example when the one or more measurements is greater than or equal to the at least one threshold. The WTRU may repeat the determination to store the one or more of the measurements as training data samples in the memory, for example when the one or more measurements is less than the at least one threshold.

The WTRU may calculate a prediction accuracy of measurements for the one or more beam-pairs, for example based on the stored training data samples. The at least one threshold may include a value which increases with the stored training data samples. Predicting measurements for the one or more beam-pairs may be based on weight vectors.

Beam inference mechanisms may be performed at a gNB and/or a WTRU. Beam inference mechanisms at the gNB may be used to reduce WTRU computational complexity. Additionally, or alternatively beam inference mechanisms at the gNB may cause the WTRU to provide certain feedback (e.g., L1-RSRP) to the gNB. RSRP compression methods may be implemented, for example to reduce AS feedback overhead. Feedback overhead may be reduced, for example if beam inference is performed at the WTRU (e.g., because the WTRU may predict the preferred beams (e.g., CRI) instead of reporting measured L1-RSRPs). Power consumption may increase, for example if beam inference is performed at the WTRU (e.g., due to the computation complexity of beam inference).

Beam inference techniques may be based on spatial domain (SD) beam selection, for example for predicting wide or refined beams. Beam management and/or beam predictions based on an AI/ML framework may resolve challenges in beam measurement and reporting and/or training and validation of the AI/ML mode, for example in scenarios where hierarchical spatial relations and beam associations are in different frequency ranges.

Beam management (e.g., in NR) may include selection and/or maintenance of a beam direction for unicast transmission (e.g., including control channel and data channel), for example between the gNB and the WTRU. Beam management procedures may be categorized into one or more of beam determination, beam measurement and reporting, beam switching, beam indication, and/or beam recovery. In beam determination for example, the base station (BS) and the WTRU may identify a beam direction (e.g., to ensure good radio link quality) for the unicast transmission (e.g., including control and data channel).

A WTRU may measure the link quality of one or more (e.g., multiple) transmission (Tx) and/or reception (Rx) beam pairs, for example after a link is established. The WTRU may report the measurement results to the BS. WTRU mobility, orientation, and/or channel blockage may affect the radio link quality of the Tx and Rx beam pairs. The BS and the WTRU may switch to another beam pair (e.g., with a better radio link quality), for example if the quality of the current beam pair degrades. For example, a BS and a WTRU may switch to another beam pair if a quality of the current beam pair falls below a threshold. In order to switch to another beam pair for example, the BS and/or the WTRU may monitor the quality of the current beam pair and/or one or more other beam pairs.

When a BS assigns a Tx beam to a WTRU for example (e.g., via DL control signaling), a beam indication procedure may be used. Beam recovery may include a recovery procedure. The recovery procedure may, for example, be used if a link between the BS and the WTRU is no longer able to be maintained.

Beam measurement and reporting may be used for higher frequencies (e.g., FR2-1, FR2-2, Sub-THz, THz, etc). Beam selection may include beam sweeping at the gNB-side and/or the WTRU-side. The gNB and/or the WTRU may sweep beams, for example, in pre-determined direction(s). The WTRU may select a beam-pair, for example with the highest received signal quality (e.g., L1-RSRP, L1-SINR, etc.). Selection of the beam pair with the highest received signal quality may be for supporting transmission and/or reception of downlink data channel (e.g., PDSCH).

Beam management may include beam sweeping and/or measurements over a (e.g., large) number of antennas at the gNB and WTRU sides, for example for a gNB of L beams and for WTRU of M beams. A total of LM transmission instants may be used and/or the beam sweeping may be performed over LM combination, for example to identify an optimal beam pair. The associated latency and/or computational complexity of conventional beam selection (e.g., especially going to higher frequency bands, such as sub-THz/THz, where latency may be shown to be in order of few seconds) may be decreased by the use of data-driven inference (e.g., including using AI/ML) to achieve beam prediction in the time and/or spatial domain (e.g., which may reduce the overhead and latency and/or improve beam selection accuracy).

AI/ML may be used for beam management including, for example, beam inference in the time and/or spatial domain for overhead, latency reduction, and/or beam selection accuracy. The expected performance of an AI/ML inference model may depend one or more factors, including, for example, the spatial/time/frequency variation of channel (e.g., due to WTRU mobility or changes in the environment); beam resolution; and/or the number of sweeping beams. Techniques to enable AI/ML-based inference for predictive beam establishment/refinement may be provided. AI/ML models may be trained based on (e.g., conventional) beam sweeping and/or reporting procedures. Procedures may include inferences at the WTRU, the gNB, and/or include disjoint and joint processing scenarios.

There may be challenges associated with the prediction of refined (e.g., narrow) beams from a subset of measured beams, for example where the predicted refined/narrow beams may not be included the first measured beams (e.g., or reference signals, RS) and/or the subset of first measured beams/RSs. A gNB may transmit the inferred/predicted refined/narrow beams, for example a second set of RSs/beams. The WTRU may measure the predicted RSs/beams and/or may select one or more predicted beams/RSs. The WTRU may provide the selected beams to the gNB, for example so that the gNB can determine the transmission configuration indicator (TCI) states that are to be activated for a PDCCH and/or PDSCH transmission.

The WTRU may perform a beam search, which for example may increase the computational complexity and/or latency. The WTRU may perform a beam search if, for example, the spatial information of the predicted RSs/beams is unknown to the WTRU. The computational complexity and/or latency may further increase as the number of antennas at the gNB and/or WTRU increases (e.g., the likelihood that the inferred refined/narrow beams are not among the measured beams and/or the subset of measured beams increases). The WTRU may perform (e.g., may frequently perform) additional beam searches, which may for example increase beam management latency.

Described herein are techniques that may reduce measurement and/or reporting overhead for beam sweeping, for example through data-driven beam prediction(s). Techniques associated with configuring predictive beam refinement may be provided. Techniques associated with data-driven WTRU-specific beam refinement may be provided. Techniques associated with indicating predictive beam operation and/or reporting predicted beam(s) (e.g., beam indices and measurement values) between the gNB and the WTRU may be provided. Techniques associated with model performance monitoring and/or triggers for retraining may be provided.

Techniques associated with WTRU predictive beam refinement may be provided herein. A gNB may configure a WTRU with predictive beam refinement/establishment. The WTRU may utilize beam sweeping for an AI/ML model training. The WTRU may indicate a data-driven prediction to the gNB. The WTRU may signal a predictive Rx beam to the gNB. The AI/ML model may perform monitoring for retraining.

Techniques associated with gNB predictive beam refinement may be provided herein. A gNB may use WTRU measurements and/or additional WTRU indications to predict an Rx beam. The WTRU measurements and/or additional WTRU indications may be historical. The gNB may signal a predictive receiver beam to the WTRU. An AI/ML model may perform monitoring, for example for retraining.

Techniques described herein may reduce measurement and/or reporting overhead for beam sweeping, for example through data-driven beam prediction. One or more of the following may be provided: techniques associated with configuring predictive beam refinement, techniques associated with data-driven WTRU-specific beam refinement, techniques associated with indicating predictive beam operation and/or reporting predicted beam(s) (e.g., beam indices and measurement values) between a gNB and a WTRU, and/or techniques associated with model performance monitoring and/or triggers for retraining.

AI/ML may be an example enabler for data-driven predictive beam refinement, however, other data driven techniques may additionally, or alternatively, be used. An RS resource set may refer to an RS resource and/or a beam group. yᵢ may denote beam quality measurement(s) sample i. yᵢ may be a vector for multiple beams or may be a scalar, for example when a single beam is used (e.g., L1-RSRP). wᵢ may denote beam combining/receiver weights sample i. wᵢ may be a matrix for multiple beams and/or a vector for single beam.

Methods for dis-joint and/or joint WTRU and gNB predictive beam refinement may be provided. Data-driven beam prediction and/or establishment may be performed, for example via an AI/ML model. Configuration information, for example associated with beam sweeping, may be received by the WTRU. The configuration information may include a buffer size. The buffer size may be associated with an AI/ML model and/or one or more threshold. The one or more threshold may include a threshold amount of memory comprising stored training data samples and/or a quality threshold (e.g., quality metric). Beam sweeping may be performed across one or more beams, for example, based on the configuration information. The AI/ML model may be trained, for example based on the beam sweeping performed across the one or more beams. For example, the AI/ML model may be implemented at a WTRU and/or a network node (e.g., a gNB). Training the AI/ML model may alternatively, or additionally include determining a quality metric. The quality metric may be associated with each of the one or more beams for which beam sweeping is performed. Training the AI/ML model may alternatively, or additionally include filling a buffer associated with AI/ML model, for example based on whether the determined quality metric associated with each of the one or more beams is greater than the threshold (e.g., received via the configuration information). Using the AI/ML model for example, a beam of the one or more beams may be identified and/or an indication of the identified beam may be sent. After the beam has been identified, a quality metric associated with the identified beam may be periodically measured. The AI/ML model may be retrained, for example if the quality metric associated with the identified beam is below a second threshold.

Methods for WTRU predictive beam refinement may be provided. A gNB may configure a WTRU with predictive beam operation. The configuration may include one or more of aspects for a buffer, beam quality, number of beams, etc. The WTRU may utilize an RS transmission-based beam sweep for model training. Training may be performed online and/or offline. The WTRU may send an indication to the gNB that predictive beam refinement/establishment is possible. For example, beam prediction may reduce and/or alleviate conventional beam sweeping (e.g., fewer or no RS transmissions). Receiver beamforming may be signaled by the WTRU, for example, explicitly signaled, to the gNB. For example, if the predicted refined/narrow beams are not included in the first measured beams (e.g., or reference signals, RS) and/or the subset of first measured beams/RSs, the receiver beamforming may be signaled by the WTRU.

A WTRU may be configured by the gNB for predictive beam operation. The WTRU may include data-driven capabilities (e.g., AI/ML capabilities). The gNB may configure the WTRU, for example, with a buffer of size and/or indicate a number of past samples of beam quality measurement(s)/beam combining weight pairs. The beam quality measurement(s)/beam combining weight pairs may be used to predict the beam(s) (e.g., in a next transmission opportunity). For example, the buffer size (e.g., window length N) used store historical beam sweeping values {(y₀,w₀), . . . , (y_{N-1},w_{N-1})} to predict a next weight vector, e.g., (y_{T}, w_{T}) may depend on the performance (e.g., accuracy) requirements, number of beams, and/or etc. The buffer size indication may be accompanied with one or more other metrics. Metrics may include, for example, one or more of a counter/timer for AI/ML model training, a time unit(s) for beam prediction, a number of beams, etc.

A gNB may configure a WTRU with a one or more thresholds (e.g., sets of thresholds), for example for the quality of the beams to store in buffer. The threshold(s) may be based on one or more of SNR/ACK/NACK statistics (e.g., measured at the WTRU), an amount of time elapsed (e.g., since the start of a counter), a beam estimation/prediction error, and/or the number of configured RSs. The beam estimation/prediction error may be a normalized mean square error (NMSE) between other (e.g., conventional) beam sweeping based output and/or beam predictor based output (e.g., using the techniques described herein). The number of configured RSs may be greater than the buffer size, for example, if the RS/beam sweeping measurement do not meet the quality threshold (e.g., additional beams may be used or required to fill the buffer).

A WTRU may be configured with AI/ML models, for example for beam prediction based on the number of beams. For example, X beams may be associated with an AI/ML model with a dimension X. The gNB may indicate the number (e.g., the total number) of beams that may be predicted (e.g., inclusive of other users taking beam possibilities). The gNB may configure the WTRU to predict and/or report X beams. The gNB may identify any X_{c} (e.g., out of X) beams, for example, depending on multi-user interference/requirements.

A WTRU may receive and/or measure one or more RS resource sets, for example for beam prediction performance measurement(s) (e.g., model training). RS resource sets may be selected from one or more of periodic, aperiodic, and/or semi-static resource sets. A gNB may transmit a configuration to the WTRU. The WTRU may be configured with a set of RS resource sets (e.g., via one or more or RRC, MAC CE and/or DCI). The WTRU may receive/request one or more RS resource sets of the set of RS resource sets, for example based on the configuration. The WTRU may request one or more RS resource sets from a gNB, for example based on one or more of quality measurement(s), and/or UL signals and/or channels. The WTRU may request one or more RS resource sets from a gNB, for example if the measured quality is lower than (e.g., or equal to) a threshold for requesting the one or more RS resource sets (e.g., block error rate (BLER) (or BER), SINR (or SNR), etc.). The threshold may be configured/indicated by the gNB (e.g., via one or more of RRC, MAC CE and DCI) and/or determined by the WTRU. The WTRU may request one or more RS resource sets from a gNB, for example if the WTRU is configured with a dedicated UL resource for requesting the one or more RS resource sets (e.g., PUCCH, PUSCH, PRACH, SRS).

The WTRU may transmit one or more reports to the gNB. The report may include an indication that the stored training data samples have reached the at least one threshold. The gNB may transmit one or more RS resource sets to the WTRU, for example if one or more conditions are met (e.g., based on one or more of the WTRU's reports). The WTRU may measure the one or more RS resource sets. The one or more conditions may be predefined and/or indicated by the gNB. The one or more WTRU reports may be based on one or more of, ACK/NACK, CSI report, and/or BLER. The WTRU may receive transmission of the one or more RS resource sets. The WTRU may receive the one or more RS resource sets in the most recent resource(s) of the one or more RS resource sets, for example after the WTRU report +N (e.g., in terms of us, ms, symbols or slots). The threshold may be configured/indicated by the gNB (e.g., via one or more of RRC, MAC CE and/or DCI) and/or may be determined by the WTRU.

A WTRU may perform AI/ML model training and/or inferences, for example for predictive beam refinement/establishment. The AI/ML model may be trained (e.g., with training data). Samples (e.g., historical samples) of the L1-RSRP, and/or combining weight vector(s) (e.g., {(y₀, w₀), . . . (y_{T-1}, w_{T-1})} may be used to predict a next weight vector (y_{T}, w_{T}). During training for example, an error measurement may include

$${E}_{ch \cdot dist} {\vert {w}_{T}^{pred} - {w}_{T}^{true} \vert}^{2} .$$

The standards for populating training samples may be provided, for example where exhaustive beam sweeping may be used to identify the weights for training.

An inference may be calculated/determined. Online training (e.g., continual training of the AI/ML model) may be utilized, for example, depending on the observed L1-RSRP values (e.g., despite online training). Mechanisms (e.g., further mechanisms) may be used to infer the performance of the beam prediction, for example if there are changes (e.g., rapid changes) in the propagation environment and/or the AI/ML's performance is not adequate (e.g., below a threshold). Triggering for exhaustive beam sweeping may be implemented. The WTRU may calculate a prediction accuracy of an AI/ML model, for example, based on the measured quality of different beams. The WTRU may create a beam-prediction reference for the AI/ML model, for example based on the measured quality of different beams. The WTRU may calculate the prediction accuracy, for example by comparing the output (e.g., predicted beam) of the AI/ML model using the beam-prediction reference. The WTRU may additionally, or alternatively, be configured to update the beam-prediction reference periodically, semi-persistently, and/or via an indication (e.g., through DCI). The WTRU may update the beam-prediction reference based on the configuration of the RSs (e.g., based on the configured CSI-RS in CSI-ResourceConfig).

Once buffer storage is executed for example, and the AI/ML model may be trained (e.g., online or offline). The WTRU may signal the buffer storage execution/model training to the gNB. The gNB may alleviate a beam sweeping process through the predictive beam refinement/establishment model. The indication transmitted by the WTRU may be explicit (e.g., through UCI/PUCCH/PDSCH, etc.), or implicit (e.g., through selection of certain UL resource (PUSCH/PUCCH/SRS, etc.).

Receiver beamforming may be signaled by the WTRU (e.g., explicitly signaled) to the gNB. For example, receiver beamforming may be signaled by the WTRU ff the predicted refined/narrow beams are not in the first measured beams (e.g., or reference signals, RS) and/or the subset of first measured beams/RSs. The WTRU may report one or more of the predictive beam ID, codebook ID (e.g., PMI), and/or predictive L1-RSRP to the gNB. The WTRU may report the predictive beam angle of arrival (e.g., RSRP), for example to the gNB.

CSI-RS transmissions may be performed, for example for quality checking. The CSI-RS transmissions may be performed periodically, dynamically, and/or based on a threshold (e.g., RSRP, or average RSRP is less than or equal to the threshold). The network (e.g., gNB) and/or WTRU may determine if there is a problem with the channel, and/or AI/ML model performance. For example, network (e.g., gNB) and/or WTRU may determine if there is a problem with the channel, and/or AI/ML model performance if the measurement (e.g., RSRP and/or average RSRP) is below the threshold,

The CSI-RS test samples may be used to determine if there is a problem with the AI/ML and/or channel (e.g., conventional). The CSI-RS test samples used (e.g., to determine if there is a problem with the AI/ML and/or channel) may be based on the reported quality. The direction(s) in which CSI-RS are transmitted may be based on the quality of the reported measurements. The WTRU may request CSI-RS transmission, for example periodically, to check the prediction accuracy. The WTRU may request CSI-RS transmission semi-persistently. The WTRU may request CSI-RS transmission aperiodically, for example if the BER/SNR is less than a threshold.

The gNB may send a trigger for the WTRU to retrain/perform online training of the beam prediction model, for example if one or more of the following occur: the WTRU prediction error is above a pre-configured threshold; a counter/timer expires; and/or the gNB determines that the WTRU is to retrain/perform online training.

The gNB may send a trigger for the WTRU to retrain/perform online training, for example if the WTRU prediction error is above a pre-configured threshold. The WTRU may trigger retraining/online training of the beam prediction model, for example, if the error/discrepancy (e.g., expressed in terms of the NMSE and Cosine similarity computation, as herein) exceeds a pre-configured threshold. For example, if the NMSE is greater than a threshold T1 and/or if the Cosine is less than a threshold T2, the WTRU may trigger training/re-training of the AI/ML model. The gNB may additionally, or alternatively, have one or more thresholds that correspond to the performance metrics of the AI/ML-capable WTRUs. For example, if the WTRU reports the computed NMSE and/or Cosine to the gNB, and error performance metrics are not within the corresponding thresholds at the gNB, the gNB may send an indication to the WTRU (e.g., in DCI) to trigger training/re-training of the CSI prediction model.

The gNB may send a trigger for the WTRU to retrain/perform online training, for example if a timer/counter expires. The WTRU may start a counter/timer, for example, every time the WTRU completes training of the AI/ML model. Upon expiration of the counter/timer, the WTRU may re-train the model. The length of time set by the timer may be measured/recorded in any of the following units: time slots, symbol duration, SFN, and/or seconds/milliseconds. The counter may be measured in one or more symbols. The length of the timer/counter may be pre-configured by the WTRU and/or indicated to the gNB. The length of the timer/counter may be pre-configured by the gNB and/or indicated to the WTRU.

The gNB may send a trigger for the WTRU to retrain/perform online training, for example if the gNB determines that the WTRU is to retrain/perform online training of the AI/ML model. The gNB may determine that the beam selected by the ML model at the WTRU is not the best beam, and/or trigger training/retraining of the ML model at the WTRU. The gNB may make this determination based on a low registered throughput (e.g., in the uplink). Additionally, or alternatively, the gNB may make this determination through CSI reports, for example sent by the WTRU.

AI/ML-based predictive beam establishment/refinement may alleviate or reduce the performance of CSI-RSI/beam sweeping, for example when SINR is above a threshold. The performance of CSI-RSI/beam sweeping may be below the threshold, which may for example indicate that a problem with the AI/ML model (e.g., DNN) and/or channel condition exists. The WTRU and/or gNB may trigger AI/ML model retraining, for example if the AI/ML model is performing below the threshold. The WTRU and/or gNB may not perform predictive beam searching (e.g., the predictive beam searching techniques described herein), for example if channel conditions are causing the poor performance.

A gNB may perform predictive beam refinement. The gNB may use (e.g., historical) RSRP/beam-index values from WTRU to predict the beam receiver for the WTRU. The gNB may signal the capability of predicting beam receivers, for example, as an index (e.g., corresponding to a certain codebook and/or a look up table of transmit beam mapped to receive beam).

The gNB may predict a WTRU side beam index, for example, if there is no beam correspondence, and/or if there is a Tx or Rx beam that is suitable (e.g., above threshold). The gNB may request and/or receive additional input from the WTRU to assist with the prediction.

The gNB may send an indication to the WTRU. The WTRU may not perform beam sweeping and/or may reduce the beam sweeping space, for example if the gNB is able to predict the receiver beam at the WTRU. The gNB may send a beam index to the WTRU. Indices may indicate the Tx beam and/or the Rx beam to the WTRU.

An absolute beam indication and/or a relative beam indication may be transmitted. A WTRU may select and/or report a Rx/Tx beam index as its selected best Rx/Tx beam, for example, as part of beam selection procedure (e.g., respective CSI report) to the gNB. The report may include one or more of absolute beam indication and/or a relative beam indication. The WTRU may determine the relative beam indexing based on Rx/Tx beams, for example if the report includes a relative beam indication. The relative beam indexing may be determined based on a priority/threshold (e.g., RSRP, LOS, and so forth), for example if report includes a relative beam indication. Beam index #1 may be allocated to the beam that has the highest RSRP, beam index #2 for the beam with second highest RSRP, and so forth, for example if report includes a relative beam indication.

The WTRU may determine a new/updated (e.g., best) Rx/Tx beam, for example due to environment changes or WTRU movement/rotation). The WTRU may determine the mode of operation for reporting the updated beam index to gNB. In a first mode of operation, the WTRU may determine not to report the updated beam index if, for example, the new Rx/Tx beam has a similar (e.g., the same) spatial relation with a previously reported beam index (e.g., a beam index reported due to environmental changes, WTRU rotation, etc.). In a second mode of operation, the WTRU may determine to report the update beam index if, for example, the new Rx/Tx beam has a different spatial relation with the previously reported beam index (e.g., the beam index reported due to environmental changes, WTRU rotation, etc.). The WTRU may report the updated Rx/Tx to the gNB. The WTRU may report the beam index, if for example, the report includes a relative beam.

The WTRU may be configured to measure and/or monitor a prediction error associated with the AI/ML model. The prediction error may include a difference between the predicted beam (e.g., determined based on AI/ML model output) applicable at time T and the (e.g., actual) best beam (e.g., determined based on RS measurements) at time T. The prediction error may include an instance where the predicted beam (e.g., determined based on AI/ML model output) applicable at time T is not within the top N beams (e.g., determined based on RS measurements) at time T.

The prediction error may include the difference between the RSRP/SNR/SINR associated with predicted beam (e.g., determined based on AI/ML model output) applicable at time T and the (e.g., actual) RSRP/SNR/SINR associated with the predicted beam (e.g., determined based on RS measurements) at time T. For example, the prediction error may be determined as an average value over a period of time.

The WTRU may be configured to transmit a report. The report may include an indication of beam prediction performance, for example, based on preconfigured triggers. The report may indicate the prediction error of the AI/ML model. The WTRU may transmit a report if, for example, the prediction error is below a threshold (e.g., a preconfigured threshold). The WTRU may transmit a report, for example if the prediction error is above a threshold (e.g., a preconfigured threshold). The WTRU may transmit he report periodically (e.g., every n milliseconds or slots).

The WTRU may be configured to transmit a report that includes an indication. The indication may be associated with the AI/ML model training. The report may indicate the status of AI/ML model training. For example, the report may indicate whether the AI/ML model training is complete or ongoing (e.g., where the criteria for completion of AI/ML model training may be preconfigured). The WTRU may transmit a report, for example, if the prediction error associated with the AI/ML is greater than a threshold (e.g., a preconfigured threshold). For example, the WTRU may transmit a report every n epochs. The value of n may be configured/pre-configured by the network. The epoch may refer to a (e.g., one) complete pass of a training dataset through the learning algorithm. The WTRU may transmit a report when the model's parameters are updated, for example, after the learning algorithm processes a number of training data samples equal to a given (e.g., pre-configured) batch size. The WTRU may transmit the report periodically (e.g., every n milliseconds or slots) while training is ongoing.

The WTRU may be configured (e.g., pre-configured) with an AI/ML model performance reporting configuration. The reporting configuration may include the UL reporting resources. The UL reporting resources may include one or more of periodicity, time offset, content, size of the report, and etc. The WTRU may determine that the configuration is deactivated (e.g., by default). The WTRU may be configured to activate the AI/ML model performance reporting configuration, for example, when the WTRU starts to train the AI/ML model. The WTRU may deactivate AI/ML model performance reporting, for example when the AI/ML model training is complete). Additionally, or alternatively, the WTRU may be configured with one or more (e.g., two) reporting configurations. A first reporting configuration may be applicable/active when the AI/ML model training is ongoing. A second reporting configuration may be applicable/active when the AI/ML model is used for inference.

AI/ML-based predictive beam refinement/establishment may be performed, for example, using WTRU inferences. A WTRU may file historical samples of the WTRU's AI/ML input using, for example, CSI-RS transmission-based beam sweeping techniques. A beam (e.g., the best beam) for the predictive beam operation (e.g., TxOP ‘T’) may be identified based on the an observed RSRP (e.g., the highest RSRP value observed). The WTRU may continue to identify beams, for example, until the buffer is filled. The WTRU may indicate, to the gNB, that the buffer is full and/or that the WTRU is ready for data-driven beam refinement. The number of CSI-RS transmissions may be greater than the buffer size. The buffer may not be filled to capacity, for example, if beam prediction identifies beams that are suitable for transmission. The size of the buffer size may be determined based on RSRP requirements. Validation (e.g., monitoring) procedures may be performed. CSI-RS may be transmitted during the validation procedures, for example to determine if the accuracy of the model (e.g., AI/ML based) is sufficient (e.g., based on the difference of the observed RSRP using CSI-RS and predicted using model). The WTRU may perform beam refinement with fewer or zero (e.g., without) CSI-RS transmissions. The receiver beamforming may be (e.g., explicitly) signaled by the WTRU to the gNB, for example if the predicted refined/narrowed beams are not in the first measured beams (e.g., or RSs) and/or the subset of first measured beams/RSs. The WTRU may report one or more of the predictive beam ID, codebook ID (e.g., PMI), and/or predictive L1-RSRP to the gNB. The WTRU may report the predictive beam angle of arrival (e.g., AoA), for example to the gNB. If, for example, the RSRP observed is below a threshold, the WTRU may trigger the gNB to retrain the model (e.g., at the WTRU). The RSRP may be below the threshold, but this may not be due to the AI/ML. Techniques may be implemented to determine if the RSRP is below the threshold as a result of the AI/ML or based on something else (e.g., poor channel conditions). One or more message/metrics may be exchanged between WTRU and the gNB. Beam recovery may be performed, for example, before re-training of the AI/ML model. A partial buffer update and/or CSI-RS retransmission update (e.g., periodicity configuration, etc.) may be performed. The gNB may transmit CSI-RS for re-training and buffer filling, for example based on the network transmission parameters.

AI/ML-based predictive beam refinement/establishment may be performed, for example, using a gNB inference. The gNB may fill the buffer with (e.g., certain) beams, for example, based on the WTRU reporting of RSRP values for each Tx beam. To identify a beam (e.g., the best beam), the WTRU may utilize beam sweeping techniques. The WTRU may transmit the RSRP values observed using, for example, PUCCH/PUSCH transmissions/resources. The WTRU may gather RSRP values, for example for every Tx beam. The WTRU may send the observed RSRP values to gNB (e.g., which may reduce the amount of overhead). Using the received RSRP value for each Tx beam for example, the gNB may fill the buffer. The gNB may send a buffer filling indication to WTRU. The buffer filling indication may alternatively, or additionally indicate that the gNB is ready for data transmission. The WTRU may trigger the gNB for re-training of the AI/ML (e.g., at the gNB side), for example if the RSRP observed is below a threshold. The gNB may transmit CSI-RSs for example for retraining. Additionally, or alternatively the gNB may perform buffer filling, for example, based on the network transmission parameters.

The gNB may predict the WTRU side beam index. The WTRU side beam index may be based on further input from the WTRU. The gNB prediction may not be accurate, for example if the WTRU experiences rotations and/or movement (e.g., severe rotations and fast-movement). The WTRU may indicate whether it requests (e.g., needs) WTRU side prediction by the gNB, for example based on RSRP values. The gNB may indicate the predicted Rx beam and/or predicted Tx to the WTRU. The WTRU may determine how and/or on which beam to proceed, for example based on the predicted beams. The gNB may indicate the predicted beams using an absolute beam indication and/or a relative beam indication.

The observing RSRP may be below a threshold. If the RSRP (e.g., and/or if the data collection for AI/ML fine tuning) falls below the threshold, the gNB and/or WTRU may trigger retraining. The WTRU may configure CSI_RS_test samples. For example, if retraining for the AI/ML model is performed (e.g., based on the RSRP falling below a threshold), the WTRU may configure the CSI_RS_test samples. The CSI_RS_test samples may be used to identify which side of the AI/ML is to be retrained.

What is claimed is:

1-20. (canceled)

21. A wireless transmit/receive unit (WTRU) comprising:
a processor configured to:
receive configuration information for predictive beam refinement, wherein the configuration information comprises at least one quality threshold related to information to be used by the WTRU to predict and select one or more beam pairs;
perform one or more measurements on one or more reference signal (RS) sets;
determine to store at least a subset of the one or more measurements as training data samples in a buffer based on a comparison of the one or more measurements against the at least one quality threshold;
determine, based on a number of the stored training data samples, to begin predicting measurements for the one or more beam pairs at the WTRU or at a network entity; and
transmit information associated with the number of the stored training data samples.

22. The WTRU of claim 21, wherein the at least one quality threshold comprises at least one of a threshold related to the one or more measurements to be performed on the one or more RS sets, or a threshold number of comparisons of one or more measurements against one or more thresholds.

23. The WTRU of claim 21, wherein the processor is configured to determine, based on at least one memory threshold, to begin predicting the measurements for the one or more beam pairs at the WTRU or at the network entity.

24. The WTRU of claim 23, wherein the memory threshold comprises one or more of a buffer size threshold related to the buffer for indicating a maximum number of samples of beam quality measurements or beam combining weight pairs, or a threshold related to a maximum buffer size or a remaining buffer size.

25. The WTRU of claim 21, wherein the processor is configured to transmit the information associated with the number of the stored training data samples when the number of stored training data samples reaches at least one memory threshold.

26. The WTRU of claim 21, wherein the processor is configured to retrieve the stored training data samples from a memory based on receipt of the configuration information.

27. The WTRU of claim 21, wherein the processor is configured to repeat the determination to store at least the subset of the one or more measurements as training data samples in the buffer when the one or more measurements is less than the at least one quality threshold.

28. The WTRU of claim 21, wherein the processor is configured to calculate a prediction accuracy of the predicted measurements for the one or more beam pairs based on the stored training data samples.

29. The WTRU of claim 21, wherein the at least one quality threshold comprises a value which increases with the stored training data samples.

30. The WTRU of claim 21, wherein the processor is configured to predict the measurements for the one or more beam pairs based on weight vectors.

31. A method performed by a wireless transmit/receive unit (WTRU), the method comprising:
receiving configuration information for predictive beam refinement, wherein the configuration information comprises at least one quality threshold related to information to be used by the WTRU to predict and select one or more beam pairs;
performing one or more measurements on one or more reference signal (RS) sets;
determining to store at least a subset of the one or more measurements as training data samples in a buffer based on a comparison of the one or more measurements against the at least one quality threshold;
determining, based on a number of the stored training data samples, to begin predicting measurements for the one or more beam pairs at the WTRU or at a network entity; and
transmitting information associated with the number of the stored training data samples.

32. The method of claim 31, wherein the at least one quality threshold comprises at least one of a threshold related to the one or more measurements to be performed on the one or more RS sets, or a threshold number of comparisons of one or more measurements against one or more thresholds.

33. The method of claim 31, comprising determining, based on at least one memory threshold, to begin predicting the measurements for the one or more beam pairs at the WTRU or at the network entity

34. The method of claim 33, wherein the memory threshold comprises one or more of a buffer size threshold related to the buffer for indicating a maximum number of samples of beam quality measurements or beam combining weight pairs, or a threshold related to a maximum buffer size or a remaining buffer size.

35. The method of claim 31, comprising transmitting the information associated with the number of the stored training data samples when the number of stored training data samples reaches at least one memory threshold.

36. The method of claim 31, comprising retrieving the stored training data samples from a memory based on receipt of the configuration information.

37. The method of claim 31, comprising repeating the determining to store at least the subset of the one or more measurements as training data samples in the buffer when the one or more measurements is less than the at least one quality threshold.

38. The method of claim 31, comprising calculating a prediction accuracy of the predicted measurements for the one or more beam pairs based on the stored training data samples.

39. The method of claim 31, wherein the at least one quality threshold comprises a value which increases with the stored training data samples.

40. The method of claim 31, comprising predicting the measurements for the one or more beam pairs based on weight vectors.
